(19) United States
(12) Patent Application Publication
(10) Pub. No.: US 2016/0155357 A1
(43) Pub. Date: Jun. 2, 2016

(54) METHOD AND SYSTEM OF LEARNING LANGUAGES THROUGH VISUAL REPRESENTATION MATCHING

(71) Applicant: Shu Hung CHAN, Chai Wan (HK)

(72) Inventor: Shu Hung Chan, Chai Wan (HK)

(21) Appl. No.: 14/901,388

(22) PCT Filed: Jun. 28, 2013
(86) PCT No.: PCT/CN2013/078445

§ 371 Date: Dec. 28, 2015

(51) Int. Cl. G09B 19/06; G09B 5/06

(52) U.S. Cl. CPC G09B 19/06; G09B 5/06

(57) ABSTRACT

The invention provides a method and system of providing picture matching game play to learn at least one language by a player with a personal communication device, the method comprising the steps of: (a) the player establishing communication between the personal communication device and a language learning game system capable of generating a type of speech learning game and a type of text learning game in a game format selected from a list of game formats adopted by the language learning game system, said speech learning game or the text learning game containing at least one game content associated with a language learning item and a language learning item matching picture; (b) the player selecting a target language and the type of learning game of interest; and (c) the player engaging in the game by selecting the picture that is matched to the language learning Item contained in the learning game; wherein the learning items of the at least one language in the speech and text learning games, which are semantically the same, are correlated with the same matching picture.

### FIELD

The present invention is generally related to methods and systems for learning languages through playing computer games. More specifically, the present invention concerns a method and system of providing picture matching game play to learn at least one language by a player having a personal communication device (for example, smart phones, tablet computers, PDAs, or other electronic devices).

### BACKGROUND

The advent and popularity of personal communication devices have driven some software developers to make educational softwares and games for learning languages. However, the existing methods and systems adopted in these educational softwares and games for learning languages have a number of weaknesses and disadvantages. According to the majority of brain memory theories, most of these existing methods and systems actually contradict the ways that we should learn languages in order to achieve longer memory of and faster response to speeches and texts of a language.

U.S.2011311952A1 discloses a modularized computer-aided language learning system utilizing the matching between the text, image and sound of a subject. The system teaches a presentation module including a first description of a presentation subject and a placeholder indicating that a second description of the presentation subject is missing from the presentation module. Each of the first description of the presentation subject and the second description of the presentation subject is one of a textual type, a visual type and an audio type. Separated from the presentation module, the system presents the second description of the presentation subject, and receives a user input indicating an association of the presented second description to presentation module related to the presentation subject. Feedback is provided indicating the correctness of the association. The utilization of visual presentation and a computer game increases the user's interest in learning a language. However, this system can only generate one language learning game, which will easily become boring upon repetitive playing. Besides, this system does not allow learning the speech and the text of a language separately.

U.S.2005208459A1 discloses a progressive language learning system which combines computer games through active or passive triggered events, and which can adjust playing and learning modes progressively according to learning records and evaluation results. U.S.2004209231A1 discloses a learning system based on the use of games such as crossword puzzles to increase skills in learning languages. Words lists and clues including pictorial scenes are inserted in a computer and a game matrix is generated using stored game generation software. U.S.2004215446A1 discloses a language learning computer system in which a character moves according to the correctness of the input by the learner. These systems, however, are ineffective in generating various funny and exciting games in different game formats systematically, and are therefore limited to one learning format or one game format. As a result, the learning process may quickly become boring and monotonous for the learner.

The existing methods and systems require players to learn texts, the corresponding speeches and translations (i.e. meanings) of a new language altogether. This kind of learning process is quite boring and inefficient. The existing methods and systems also advocate learning of multiple languages one by one to avoid mixing of the learning contents. However, it is actually less effective and less efficient to learn speeches and texts of multiple languages at different times. Furthermore, only a handful of the existing methods and systems are capable of generating games which utilize pictures as an aid for learning a language, but they are not effective in generating various games in different game formats systematically. Besides, these games are not integrated with an effective and flexible mechanism to detect players' learning progress before adding new learning contents to the upcoming games so that the players can learn in a progressive way. Finally, most of these existing methods and systems do not provide an evaluation module to evaluate the language level of players and to display players' learning progress in a tangible way.

To address the above deficiencies of the existing methods and systems, there is a need for an innovative method and system, which will be capable of converting learning items (speeches/texts) of different languages into funny, interesting and challenging language games for players of personal communication devices to learning languages effectively.

### SUMMARY

The present invention has been developed to fulfill the need noted above and therefore has a principle object of the provision of method and system of providing picture matching game play to learn one or more languages by players of personal communication devices (for example, smart phones, tablet computers, PDAs, or other electronic devices using wire or wireless networks), which attempts to fulfill the task of providing a platform for the players to learn the languages in an enjoyable and effective manner.

The nature of the invention focuses on generating various funny and exciting games in different game formats systematically, providing a fun game experience. The system according to the present invention is able to adopt different game formats containing similar or same learning contents for increasing the interests of repetitive learning. Furthermore, the present invention realizes separating the speech learning from the text learning by generating the picture matching games for the speech learning and the picture matching games for the text learning. The design of separating the speech learning from the text learning leads to effective conversion of massive learning contents of speeches and texts)of one or more languages into massive picture matching games. With the method and system according to the present invention, it is easier for players to learn different kinds of speech and text learning contents separately and better results can be achieved with the aid of pictures in the learning process.

An object of the invention is to provide method and system that allow to generate various games of different game formats of the same or different game levels using the language level of the players, and that effectively manages the learning items to fit for each player's learning progress.

Another object of the invention is to provide method and system that limits the time for playing the language learning games, in order to make the games more challenging and exciting.

A further object of the invention is to provide method and system of providing the picture matching learning game play, which delivers, via the personal communication device, a learning environment that can be used anytime and anywhere to learn one or more languages. The players can learn and practice the languages wherever and whenever the players choose.

These and other objects and advantages of the invention are satisfied by a method of providing picture matching game play to learn at least one language by a player with a personal communication device, comprising the steps of:
(a) the player establishing communication between the personal communication device and a language learning game system capable of generating a type of speech learning game and a type of text learning game in a game format selected from a list of game formats adopted by the language learning game system, said speech learning game or the text learning game containing at least one game content associated with a language learning item and a language learning item matching picture;
(b) the player selecting a target language and the type of learning game of interest; and
(c) the player engaging in the learning game by selecting the picture that is matched to the language learning item contained in the learning game;
wherein the learning items of same semantic meaning in the speech and text learning games are correlated with the same matching picture.

The language learning item comprises vocabulary, phrase and sentence.

The method further comprises the step of the player selecting the specific game format for the selected game type to initiate the learning game.

One of the most important features of the language learning game system according to the present invention is that the language learning game system is designed and operated in a manner similar to an innovative video game console. It is well known in the art that game cartridges/cards containing different games may be inserted into a video game console so that the games contained in the cartridges/cards can be run by the video game console and played by the player. In the system according to the present invention, one or more additional game formats that are not contained in the language learning game system can be electronically introduced into the system. The one or more additional game formats for example, may be exogenous game formats that are designed to be compatible with the specification and/or criteria of the language learning game system, and can be introduced by means of a compact disc, a DVD, a USB memory stick, a SD card, a mobile hard drive, or a wire-based or wireless network. Therefore, an unlimited number of game formats can be adopted by the language learning game system.

In one embodiment of the present invention, the game format is presented in the form of a picture touch game where the player is required to select and touch the matching picture, or a picture movement game where the player is required to select the matching picture and move it in a right direction. One example of the picture movement game is a picture matrix game where the player is required to move the matching picture for positional swap with an adjacent non-matching picture, such that any three or more of the matching picture or the same non-matching pictures connected in a vertically or horizontally consecutive way are cleared. Then, the picture matrix game continues with a new learning item or the same learning item that is matched to any one of the pictures shown in the matrix after the clearing operation.

Furthermore, the language learning game system is capable of electronically introducing additional game contents associated with desirable learning items and corresponding matching pictures thereof into the system, so that the generated speech or text learning game contains the additional game contents. The additional game contents are introduced into the language learning game system by means of a compact disc, a DVD, a USB memory stick, a SD card, a mobile hard drive, or a wire-based or wireless network.

In another embodiment of the present invention, the language learning game system generates the speech learning game and the text learning game according to different game levels, and the player is allowed for the game play at a next game level only after the learning game at a current game level is completed. To facilitate repetitive learning of the learning items, the game content of the speech or text learning game at the next game level contains one or more language learning items originated from the previous game level or levels of the learning game, and the player is allowed to play the completed learning games of different game levels repeatedly to review the language learning items.

In a particularly preferred embodiment of the invention, the method further comprises the step of displaying a demonstration of a specific correlation of a language learning item with a matching picture thereof before, during and after the game play, thereby the player understands such a specific correlation. The demonstration includes a spoken or written translation of the language learning item into a language known by the player for the matching picture.

According to the present invention, the player may earn a player individual score for completion of each learning game, and the language learning game system accumulates the individual score of the player to form a player accumulated score. The player accumulated scores of different players may be displayed and compared to establish a sense of competition among players.

In the method according to the present invention, the language learning game system provides the speech learning game and the text learning game to learn a plurality of languages, wherein the learning items of the plurality of languages, which have the same semantic meaning, are conelated with the same matching picture.

The player may be required to engage in the learning game by selecting the matching picture within a computer-evaluated period of time to make the games more challenging and exciting.

Another aspect of the invention is to provide a system of providing picture matching game play to learn at least one language by a player with a personal communication device, comprising;
a language learning game system in communication with the personal communication device, comprising:
   a database comprising a speech sub-database for storing and updating speech learning items, a text sub-database for storing and updating text learning items, and a picture sub-database for simultaneously providing language learning item matching pictures for the speech learning items and the text learning items, wherein the speech and text learning items of at least one language, which have the same semantic meaning, are correlated with the same matching picture;
   a game generation module for generating a type of speech learning game and a type of text learning game in a game format selected from a list of game formats adopted by the language learning game system, said speech learning game or the text learning game containing at least one game content associated with a language learning item and a language learning item matching picture;
   a language selector for permitting to select a target language;
   a game type selector for permitting to select the game type for game play; and
   a module for permitting the player to engage in the game by selecting the picture that is matched to the language learning item contained in the learning game.

In one preferred embodiment of the invention, the system further comprises a game format selector for permitting to select the specific game format for the selected game type to initiate the learning game.

The language learning game system may comprise a server which is operative for reactive exchanges with the player.

The database of the language learning game system is expandable, as additional game contents associated with desirable learning items and corresponding matching pictures thereof can be introduced into the respective sub-databases.

Preferably, the game generation module is configured to generate the speech learning game and the text learning game according to different game levels, and the language learning game system further comprises a game level module configured to control the game levels of the game play such that the player is allowed for playing the game at a next game level only after the learning game at a current game level is completed.

The language learning game system may further comprise a learning contents and progress management module configured to manage the language learning items contained in the game contents of the speech or text learning games and manage the learning progress of the player. To facilitate repetitive learning of the learning items, the learning contents and progress management module permits the player to play the completed learning games of different game levels repeatedly.

In one particularly embodiment of the invention, the language learning game system further comprises a game demonstration module for demonstrating a specific correlation of a language learning item with a matching picture thereof before, during and after the game play, thereby the player understands such a specific correlation. The demonstration includes a spoken or written translation of the language learning item into a language known by the player for the matching picture.

The language learning game system may also comprise a score evaluating and recording module for evaluating and recording a player individual score earned by the player for completion of each learning game and accumulating the individual score of the player to form a player accumulated score. To induce a sense of competition among players, the score evaluating and recording module comprises a comparison module configured to compare and display the player accumulated scores of different players.

The language learning game system may further comprise a picture and learning item linkage configured to provide the same matching picture for the learning items of same semantic meaning in the speech and text learning games. The system may also be configured to comprise a speech content converter configured to convert the speech learning items of same semantic meaning of a plurality of languages into a same code and connected to the picture and learning item linkage for correlating the speech learning items with the same matching picture, and a text content converter configured to convert the text learning items of same semantic meaning of a plurality of languages into a same code and connected to the picture and learning item linkage for correlating the text learning items with the same matching picture. Alternatively, the speech learning items or the text learning items of same semantic meaning of a plurality of languages are assigned with respective identification codes, said identification codes having a same end-bit code which correlates the speech or text learning items with the same matching picture.

To make the games more challenging and exciting, the system according to the present invention further comprises a timer module for providing a time limit for playing the game.

The present invention is effective in generating various funny and exciting games in different game formats systematically, which will increase the interest of repetitive learning of the same learning content by different game formats. Unlike the prior art language learning methods and systems which do not enable learning a plurality of languages simultaneously and which teach the speech and text learning contents collectively, the method and system of the invention allows for learning different languages altogether in a more effective and efficient way instead of learning one by one. The invention separates the learning process of speech learning contents from the learning process of text learning contents so that learning the speech and text learning contents independently is feasible, thereby making the language learning easier. This is manifested by dividing the speech and text learning contents into different types of learning games and the players are permitted to select which type of games to play for the language learning. The players are required to select and touch or move the matching pictures, which helps the players to memorize the learning contents for a long time and have a faster response time to the learning contents. The design and configurations of the method and system of the invention allows for repeated learning of the same learning contents in a more interesting way, which trains up the players' listening and reading skills and strengthens the players' memory of the accurate pronunciation and spelling of a language. The different time limits will make the game play more exciting and provide a good means for evaluation of the player's scores.

The objects, characteristics, advantages and technical effects of the invention will be further elaborated in the following description of the concepts and structures of the invention with reference to the accompanying drawings.

### BRIEF DESCRIPTION OF THE DRAWINGS

FIG. 1 is an exemplary system constructed according to the invention comprising an exemplary language learning game system, illustrating the process of learning at least one language through playing picture matching games.

FIG. 2 is the picture and learning item linkage shown in FIG. 1, illustrating the table for matching of the learning items and the corresponding pictures.

FIG. 3 is the speech content converter shown in FIG. 1, illustrating the table for matching the speech learning items of different languages.

FIG. 4 is the text content converter shown in FIG. 1, illustrating the table for matching the text learning items of different languages.

FIG. 5 is an exemplary learning contents and progress management module that is used in the system of the invention, which is configured to manage the language learning items contained in the game contents of the speech or text learning games and manage the learning progress of the player.

### DETAILED DESCRIPTION

The system according to the invention is an automated system allowing for the conversion of speech and text learning items of different languages into interesting computer games in different game formats. The system integrates the language learning and innovative content design with the personal communication device (such as smart phones) to create a meaningful, amusing, pedagogical and mobile environment for the players to learn one or more languages. With the system of the invention, learning a language will be presented in an interesting and interactive way. This will interest children or even adults in learning languages.

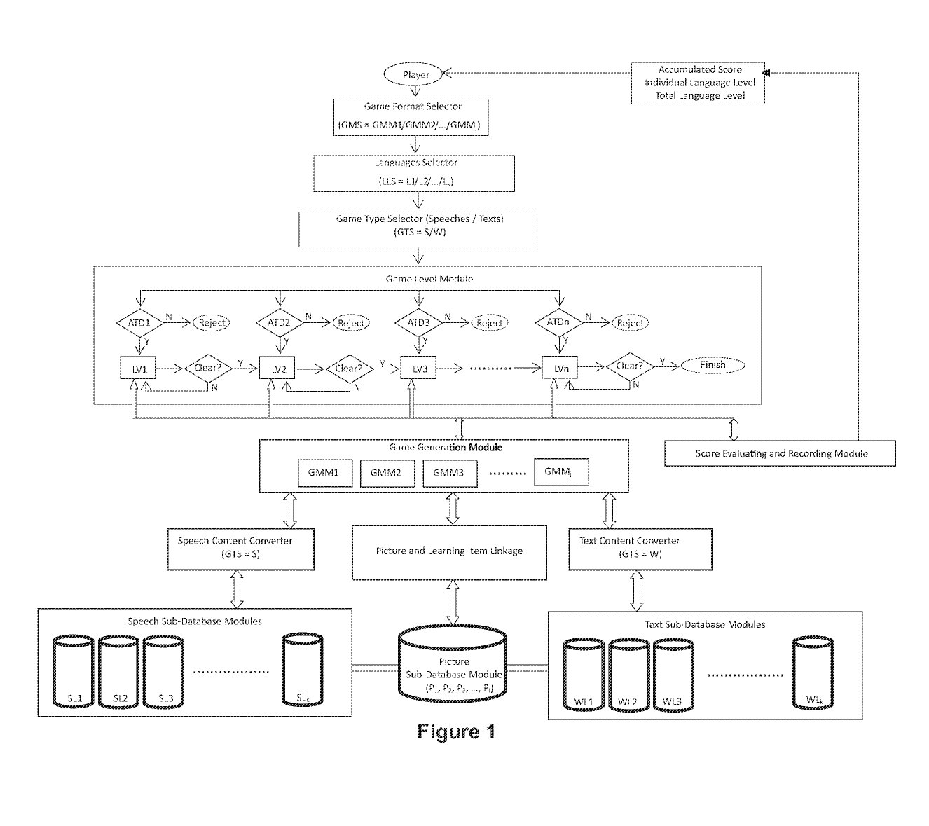

Referring now to FIGS. 1 to 5, there is illustrated an exemplary system of providing picture matching game play to learn a plurality of languages, which includes a language learning game system in communication with a personal communication device of the player. The language learning game system comprises a server (not shown) operative for reactive exchanges with the player. The server is used for managing actions, reactions and exchanges between the player and the language learning game system

The personal communication device can be a computer, a mobile smart phone or any computing device that contains the application software (Apps) of the language learning game system for displaying player interfaces (Interfaces) and is in interactive communication with the server.

The language learning game system further comprises a database for storing and updating language learning items contents related to different languages and pictures that are matched to the language learning items. In particular, the database comprises a speech sub-database for storing and updating speech learning items, a text sub-database for storing and updating text learning items, and a picture sub-database for simultaneously providing language learning item matching pictures for the speech learning items and the text learning items, wherein the speech and text learning items of the different languages, which have the same semantic meaning, are correlated with the same matching picture. The speech and text learning items may be vocabulary, phrases and sentences, each of which can be represented by a code Ty where y=1, 2, 3, . . . , i. Each learning item (Ty) is correlated with a picture (represented by Py where y=1, 2, 3, . . . , i) that contains the corresponding meaning of the vocabulary, phrase or sentence.

The language learning game system further comprises a game generation module for generating a computer speech learning game using the speech learning items stored in the speech sub-database or generating a computer text learning game using the text learning items stored in the text sub-database, responsive to a request of starting the game play. The generated learning game contains at least one game portion associated with a speech or text learning item which can be vocabulary, phrases and sentences, and a language learning item matching picture. Apart from this game portion, the generated learning game may contain other game portions related to music, animation or pet animals or amusing and appealing background contents, which would be within the ability of a person skilled in the art.

Preferably, the game generation module is configured to generate the speech or text learning games at different game levels that are suitable for the players. The language learning game systems thus further comprises a game level module for controlling the game levels of the game play, and this module would be configured to allow the players to play the learning game at a next game level only after the game at a current game level is completed.

The speech or text learning game can be presented in a specific game format selected from a list of game formats adopted by the system for increasing the interest of learning. For example, the game format may be the game format is presented in the form of a picture touch game and the player is required to select aid touch the matching picture, or may be a picture movement game and the player is required to select the matching picture and move it in a right direction. One example of the picture movement game is a picture matrix game where the player is required to move the matching picture for positional swap with an adjacent non-matching picture, such that any three or more of the matching picture or the same non-matching pictures connected in a vertically or horizontally consecutive way are cleared. Then, the picture matrix game continues with a new learning item or the same learning item that is matched to any one of the pictures shown in the matrix after the clearing operation. Accordingly, the language learning game system provides a game format selector which allows the players to select the game format of interest. With this design, the players may be involved in challenging and interesting computer games while they can learn the language effectively and efficiently.

One of the important features of the present invention is that besides the game formats contained, the language learning game system is capable of electronically introducing one or more additional game formats that are not contained in the language learning game system, so that the speech learning game or the text learning game is generated in the introduced game formats. The one or more additional game formats may be exogenous game formats that are designed to be compatible with the specification and/or criteria of the language learning game system, and can be introduced into the language learning game system by means of a compact disc, a DVD, a USB memory stick, a SD card, a mobile hard drive, or a wire-based or wireless network. Therefore, an unlimited number of game formats can be adopted by the language learning game system. Similarly, additional game contents associated with desirable learning items and corresponding matching pictures thereof can be electronically introduced into the language learning game system, so that the generated speech or text learning game contains the additional game contents. In other words, the database of the language learning game system is expandable.

The language learning game system further comprises a language selector which allows the players to select any one target language among the plurality of the languages at their own interest so that the generated picture matching games contain the learning contents of the selected languages. The language learning game system further comprises a game type selector which allows the players, after the target language is selected, to which type of learning game to play, the speech learning game or the text learning game.

The language learning game system further comprises a module for permitting the player to engage in the game to provide an answer by selecting the picture that is matched to the language learning item contained in the learning game. This module allows the player to listen or read the game content including the speech learning items or the text learning items and then provide the correct answer by selecting the correct matching picture within a computer-evaluated period of time.

The language learning game system further comprises a timer module for providing the time limit for selecting one or more matching pictures to each game, and a score evaluating and recording module for evaluating the player's individual score (PIS) gained from completion of each of the game play. The score evaluating and recording module is configured to evaluate, update, and record the PIS of each player as well as accumulate the PIS to form a player's accumulated score (PAS). This module further comprises a comparison module which compares and displays the PIS and PAS of each player and the different players.

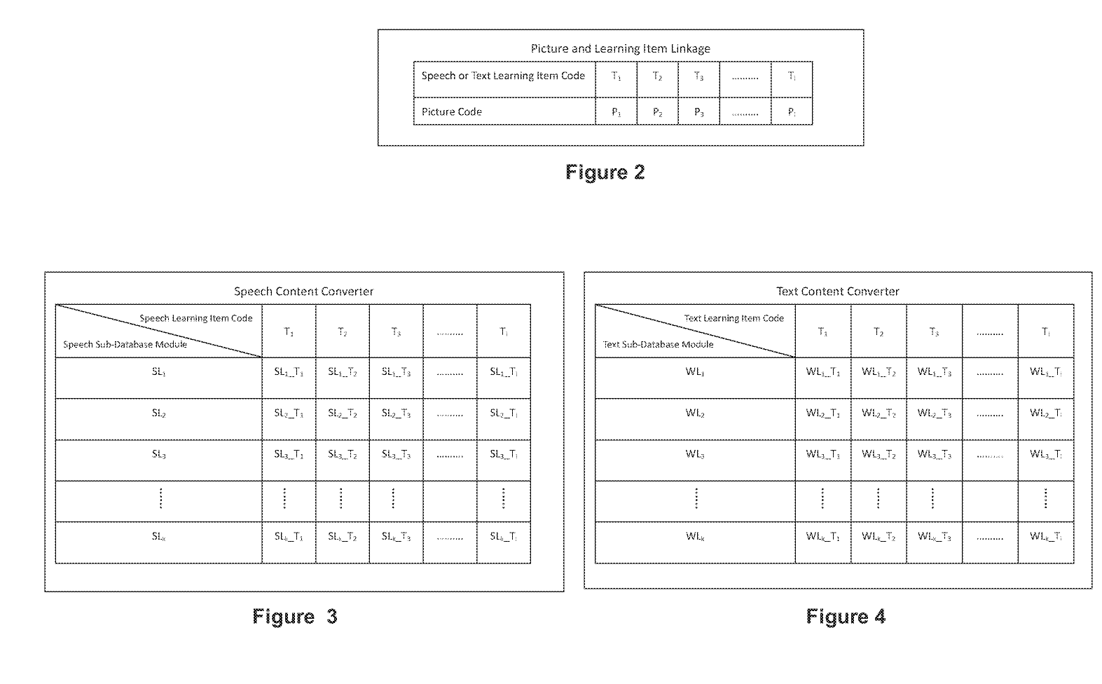

As discussed above, one of the distinctive features of the invention is that the learning items of different languages in the speech learning games and in the text learning games, which have the same meaning, would be correlated to one same matching picture. This helps to save memory space required for the language learning game system. To implement this, the language learning game system comprises a picture and learning item linkage which provides the same matching picture for the learning items of same meaning in the speech and text learning games; a speech content converter for converting the speech learning items of same meaning of different languages into a same speech code and connected to the picture and learning item linkage for correlating the speech learning items of the same meaning with the same matching picture; and a text content converter for converting the text learning items of same meaning of different languages into a same text code and connected to the picture and learning item linkage for correlating the text learning items with the same matching picture. The same speech code or the same text code is correlated to the same matching picture. As shown in FIG. 2, the picture and learning item linkage contains a plurality of learning item codes T₁, T₂ . . . Tₙ, and a plurality of picture codes P₁, P₂ . . . Pₙ, which correspond to the learning item codes. Each learning item code is correlated with its corresponding picture code. The picture and learning item linkage would provide the matching picture for the target learning item according to the code correspondence therebetween as shown.

FIGS. 3 and 4 illustrate the speech content converter and the text content converter connected with the picture and learning item linkage, respectively. The speech content converter contains a plurality of speech learning item codes T₁, T₂ . . . Tₙ, and a plurality of selected language codes SL₁_{_}T₁, SL₁_{_}T₂ . . . SL₁_{_}Tₙ for language 1; SL₂_{_}T₁, SL₂_{_}T₂ . . . SL₂_{_}Tₙ for language 2; and SLₖ_{_}T₁, SLk_T₂ . . . SLₖ_{_}Tₙ for language k; all of which correspond to the learning item codes. The speech content converter is configured to convert the language codes, for example SL₁_{_}T₁, SL₂_{_}T₁ . . . SLₖ_{_}T₁ of different languages, which have the same meaning, into the same speech code, for example T₁. According to this converted speech learning item code, the picture and learning item linkage connected to the speech content converter would provide the corresponding matching picture for the learning item according to the code correspondence shown therein.

Likewise, the text content converter contains a plurality of text learning item codes T₁, T₂ . . . Tₙ, and a plurality of selected language codes WL₁_{_}T₁, WL₁_{_}T₂ . . . WL₁_{_}Tₙ for language 1; WL₂_{_}T₁, WL₂_{_}T₂ . . . WL₂_{_}Tₙ for language ₂; and WLₖ_{_}T₁, WLₖ_{_}T₂ . . . WLₖ_{_}Tₙ for language k; all of which correspond to the learning item codes. The text content converter is configured to convert the language codes, for example WL₁_{_}T₁, WL₂_{_}T₁ . . . WLₖ_{_}T₁ of different languages, which have the same meaning, into the same text code, for example T₁. According to this converted text learning item code, the picture and learning item linkage connected to the text content converter would provide the corresponding matching picture for the learning item according to the code correspondence shown therein.

Alternatively, the speech learning items of same meaning of different languages may be assigned with respective speech identification codes, said speech identification codes having a same end-bit code which correlates said speech learning items with the same matching picture. Likewise, the text learning items of same meaning of different languages may be assigned with respective text identification codes, said text identification codes having a same end-bit code which correlates said text learning items with the same matching picture.

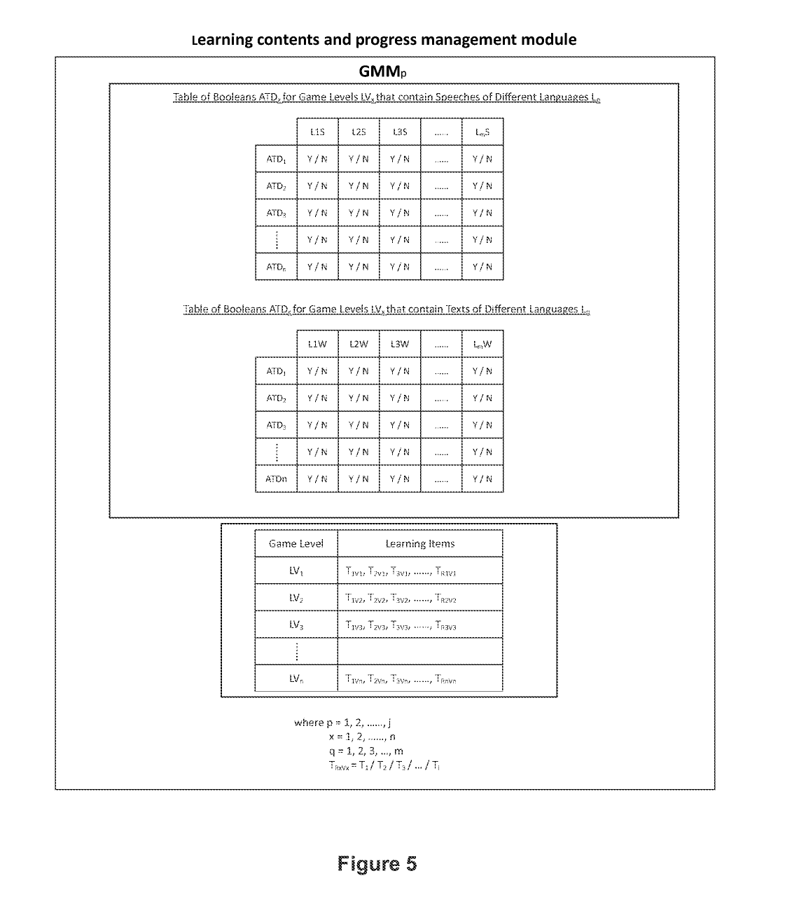

The language learning game further comprises a learning contents and progress management module which manages the language learning items contained in the game contents of the speech or text learning games, as shown in FIG. 5. FIG. 5 illustrates the table of Booleans ATDx for a game level LVx that contains speeches of a specific languages and the table of Booleans ATDx for a game level LVx that contains texts of a specific languages. It also illustrates different learning items for each game level. The learning contents and progress management module is configured to help and permit the players to play the completed learning games or review the learning items that have been learned previously, thereby to manage and monitor the learning progress of the players, which will be described in more detail with reference to the specific learning games herein below. Therefore, the player will find it more interesting in playing the learning games for repeatedly learning the same learning items. This ensures that the players will get better memory of the learning items.

Another distinctive feature of the language learning game system is that it comprises a game demonstration module which demonstrates a specific correlation of a language learning item with a matching picture thereof before, during and after the game play, thereby the player understands such a specific correlation. The demonstration includes a spoken or written translation of the language learning item into a language known by the player for the matching picture. In some cases, it is hard to use a picture to depict a speech or text language learning item, this module would demonstrate the specific correlation of the picture with the learning item, enabling the players to clearly grasp the correlation when they are playing the learning games.

According to the invention, the modules and the units of the language learning game system discussed above may be provided either in the server or in the player's side.

The advantages of the invention include one or more of the following:
providing a platform for converting massive speech and text learning contents of different languages into various picture matching games, which enhances the enjoyment of learning languages;
designating a same matching picture to the speech and text learning items of different languages, which are of same semantic meaning, such that less memory space is required for learning different languages;
generating picture matching games in different game formats that may contain the same or similar learning content to make repetitive learning of the sane or similar learning items more interesting;
capable of adopting an unlimited number of game formats that are not contained and that are designed to be compatible with the system;
capable of expanding the database by introducing additional game contents;
allowing the players to choose at their own preferences to learn any specific language and choose to learn its speeches or its texts any time without following any strict rule or a preset process;
effectively managing the learning items to fit for each player's learning progress;
permitting the players to learn by mistake as the mechanism offered by the invention allows them to replay the current game level that contains the same learning items and/or some of the previously learnt items until they can complete the game level; and
encouraging the players to learn different languages by providing total language level for each player, which is evaluated from the consolidation of the player's Individual Language Levels for different languages.

The following description of the invention will describe the generation of some examples of the speech and text learning games using the system of the invention, and how the players are involved in the learning games to learn the language or languages.

### Abbreviations, Denotations and Terms

The following abbreviations, denotations and terms used herein refer respectively to the definitions below:

GMS: game format selected through the Game Format Selector
GMS=GMM1/GMM2/ . . . /GMMj
where GMMp presents game format p
   LLS: language selected through the Language Selector
LLS=L1/L2/ . . . /Lk
where Lq represents language q
   GTS: game type selected through the Game Type Selector
GTS=S/W
where S represents speeches and W represents texts
   LVx: game level x
   ATDx: Boolean that determines if a player is allowed to directly play on game
level LVx
ATDx=Y/N
where Y is for Yes and N is for No
   Completed?:It is a function to check if a player has completed the current game level or not,
where Y is for Yes and N is for No
   SLq: Speeches Sub-Database for language q (Lq)

### WLq: Texts Sub-Database for Language q (Lq)

Ty: learning item (code)
Py: picture for the learning item Ty
SLq_Ty: speech of language q (Lq) for the learning item Ty
WLq_Ty: text of language q (Lq) for the learning item Ty
Try: learning item (code) randomly selected from previously learnt learning items
Values: j, p, k, q, x, y, i, n and m are any integers (1, 2, 3, . . . )
System Flow of the Method according to the Present Invention

The first step of the system flow of the method according to the present invention is to establish communication between the personal communication device and the language learning game system. Such communication can be established through remote data transfer, for example, via the Internet, or by installing the learning game system on the personal communication device.

After the communication has been established, as shown in FIG. 1, the player will preferably enter the Game Format Selector, which allows the player to select one of the game formats in which the picture matching game will be generated by the language learning game system. Alternatively, the language learning game system can randomly select one of the game formats for the player.

Then, in the Language Selector, the system allows the player to select any one or more of the languages (L1, L2, . . . Lk) as the target language(s) such that the generated picture matching games will contain learning items of the selected language(s).

Next, in the Game Type Selector, the player can select to learn speeches (GTS=S) or texts (GTS=W) of the selected language(s) in the picture matching games.

By going through the above selection processes, the player will enter the Game Level Module that controls if the player is allowed to play on any game level LVx of the system. It controls if the player on the current game level LVx can be promoted to play on the next game level LV(x−1) according to the determination of the Learning Contents and Progress Management Module. It also controls if the player is allowed to directly play on a specific game level LVx according to the Boolean ATDx of the Learning Contents and Progress Management Module.

On a game level LVx, the Game Generation Module will generate the required picture matching games of the selected game format for the game level LVx and display these picture matching games on the user interface. These picture matching games will contain the learning items selected by the Learning Contents and Progress Management Module.

The Picture and Learning Item Linkage will be applied to correlate any learning items to corresponding pictures and to provide any additional pictures for the picture matching games according to the pictures stored in the Picture Sub-Database.

If GTS=S, then the Speech Content Converter will be applied to convert the learning items of the game level LVx to speeches of the selected language according to the speeches stored in the Speech Sub-Database. The Game Generation Module will use these speeches for generating picture matching games for learning speeches.

If GTS=W, then the Text Content Converter will be applied to convert the learning items of the game level LVx to texts of the selected language according to the texts stored in the Text Sub-Database. The Game Generation Module will use these texts for generating picture matching games for learning texts.

These processes enable that the picture matching games are generated by using the selected Game Format with speeches or texts of the selected language.

The Game Level Module works with the Game Generation Module to provide an effective mechanism to manage the player's learning progress through controlling the player's access to play on different game levels that contain different learning items. According to the player's performance on the current game level LVx, the Learning Contents and Progress Management Module determines if the player has fulfilled the requirement(s) to complete the current game level. If the player has completed the current game level LVx, the Game Level Module will promote the player to play on the next game level LV(x+1) that contains picture matching game(s) of other learning items. Otherwise the player is not allowed to play on the next game level LV(x+1).

The Game Level Module also works with the Game Generation Module to provides a flexible mechanism that allows the player to play on any of the previously completed game levels such that the player can replay those picture matching games that contain the previous learning items for re-practicing. The Learning Contents and Progress Management Module determines if the player fulfills the requirement(s) to directly play on any game level by using the Boolean ATDx for respective game levels LVx (where x=1, 2, . . . n). It sets the value of the Boolean ATDx for a game level LVx to “Y” if the player fulfills the requirement(s) to directly play on the game level LVx; otherwise it sets the value of the Boolean ATDx to “N”. The Game Level Module will allow the player to directly play on the game level LVx if ATDx=Y, otherwise it will not allow the player to directly play on the game level LVx.

After completing each picture matching game, the Score Evaluating and Recording Module will evaluate and update the player's Accumulated Score, Individual Language Levels and Total Language Level.

### The Picture Matching Games

In the preferred embodiment of the present invention, the language learning game system is capable of generating two types of picture matching games: picture matching games for learning speeches of a language and picture matching games for learning texts of a language. In a picture matching game for learning speeches of a language, the player is required to listen to the provided speech and select the picture(s) that match the corresponding meaning of the speech by touching or moving the picture(s) so as to achieve a target required by the game. In a picture matching game for learning texts of a language, the player is required to see the provided text and select the picture(s) that match the corresponding meaning of the text by touching or moving the picture(s) so as to achieve a target required by the game.

These picture matching games take advantages of effective and efficient learning of languages in a visual format. To ensure progressive learning, each game format will consist of progressive game levels such that each game level contains different learning items for generating picture matching games. Some of the game levels may contain new learning items. Some may contain a combination of the learning items used in the previous levels to test the player's memory of the previously learnt items. Some may contain both new learning items and a combination of the learning items used in the previous levels. The player is required to fulfill the requirement(s) to complete a game level before being promoted to the next one. The higher the game levels are, the more difficult they may be because more of previous levels are completed and thus more learning items may be accumulated to test the player. This will not only make the games on the higher game levels more challenging but also lead players to memorize what they have learnt for a longer time.

To achieve repetitive learning, the same speech may appear repeatedly and/or intermittently between other speeches in each game and/or in different games. Similarly the same text may also appear repeatedly and/or intermittently between other texts in each game and/or in different games. The system also allows the player to repeatedly play on a game level such that the player can learn by mistake until the player can complete the game level. Furthermore, the player is allowed to replay the previous game levels in order to strengthen what the player has learnt and to make it easier to complete the higher game levels that may contain a combination of the learning items on the previous game levels. This induces the player's willingness to review and practice what the player has previously learnt. Besides, different game formats may be adopted to generate picture matching games of the same or similar learning items such that learning the same or similar learning items repetitively will be more interesting.

To achieve flexibility and enhance interests of learning speeches or texts of languages, the player can choose to learn any specific language and then choose to learn its speeches or its texts any time without following any strict rule or a preset process. On the other hand, to make the language learning process more systematic and focused, picture matching games of the same game level may be designed in a way to include words, phrases and/or sentences of the same category.

To increase the excitement of the game formats and to practice the learners' response time to speeches and texts, a timer may be added to the game formats such that player is required to match speeches and pictures (or texts and pictures) within a specified time limit. Similarly a timer may also be added to the game formats such that the player is required to complete a picture matching game within a specified time limit.

After completing each picture matching game or each gameplay level for learning a language, the player's scores from the game or from the gameplay level will be evaluated by the system. These scores will be accumulated to form the player's Accumulated Score. Besides the player's achievements on the gameplay levels for the same language will be used for evaluating the player's Individual

Language Level for that language. All the player's Individual Language Levels for different languages will be consolidated to form the player's Total Language Level to reflect the player's overall language knowledge for different languages provided by the system, These scores and language levels will reflect the player's learning progress and motivate the player to learn different languages. As a game system, these factors will also avoid player's inclination to acquire higher score and/or higher level by just playing the language(s) that the player is familiar with. To establish the sense of competition among players, a comparison module may be added to the system such that players can easily compare their score and/or level with their friends and/or any other players. This will motivate the players to play and learn more in the system to compete with each other.

### Example of Application of the System

In this example, the Game Generation Module is capable of generating picture matching games in two game formats (GMM1 and GMM2). Therefore the Game Format Selector will provide these two game formats for the player to select.

GMM1; game format 1 is a kind of picture matching games called Picture Touch Games,
GMM2: game format 2 is a kind of picture matching games called Picture Movement Games.

The system provides the following languages for selection in the Language Selector.
L1: English Language
L2; Chinese Language
L3; Japanese Language

The Picture and Learning Item Linkage correlates a learning item Ty to the corresponding picture Py according to the following table.

### Picture and Learning Item Linkage;

| | | | | | | | |
|---|---|---|---|---|---|---|---|
| Learning Item | T1 | T2 | T3 | T4 | T5 | T6 | T7 |
| (Code) | | | | | | | |
| Picture (Code) | P1 | P2 | P3 | P4 | P5 | P6 | P7 |

where Py denotes an image file of filename: Py.png stored in the Picture Sub-Database.

The Speech Content Converter correlates a learning item Ty of the selected language Lq to the corresponding speech SLq_Ty by using Speech Sub-Database SLq according to the following table.

### Speech Content Converter:

| | T1 | T2 | T3 | T4 | T5 | T6 | T7 |
|---|---|---|---|---|---|---|---|
| SL1 | SL1_T1 | SL1_T2 | SL1_T3 | SL1_T4 | SL1_T5 | SL1_T6 | SL1_T7 |
| SL2 | SL2_T1 | SL2_T2 | SL2_T3 | SL2_T4 | SL2_T5 | SL2_T6 | SL2_T7 |
| SL3 | SL3_T1 | SL3_T2 | SL3_T3 | SL3_T4 | SL3_T5 | SL3_T6 | SL3_T7 |

where SLq_Ty denotes a sound file of speech with filename: SLq_Ty.mp3 for language Lq stored in the Speech Sub-Database SLq.

### SL1: Speech Sub-Database for English Language

### SL2: Speech Sub-Database for Chinese Language

### SL3: Speech Sub-Database for Japanese Language

The Text Content Converter correlates a learning item Ty of the selected language Lq to the corresponding text WLq_Ty by using Text Sub-Database WLq according to the following table.

### Text Content Converter:

| | T1 | T2 | T3 | T4 | T5 | T6 | T7 |
|---|---|---|---|---|---|---|---|
| WL1 | WL1_T1 | WL1_T2 | WL1_T3 | WL1_T4 | WL1_T5 | WL1_T6 | WL1_T7 |
| WL2 | WL2_T1 | WL2_T2 | WL2_T3 | WL2_T4 | WL2_T5 | WL2_T6 | WL2_T7 |
| WL3 | WL3_T1 | WL3_T2 | WL3_T3 | WL3_T4 | WL3_T5 | WL3_T6 | WL3_T7 |

where WLq_Ty denotes the text format of the text in the corresponding position of the table shown below. (Example: WL1_T2=Orange)

### WL1: Text Sub-Database for English Language

### WL2: Text Sub-Database for Chinese Language

### WL3: Text Sub-Database for Japanese Language

| | T1 | T2 | T3 | T4 | T5 | T6 | T7 |
|---|---|---|---|---|---|---|---|
| WL1 | Apple | Orange | Banana | Papaya | Grape | Cherry | Lemon |
| WL2 | [symbol] | [symbol] | [symbol] | [symbol] | [symbol] | [symbol] | [symbol] |
| WL3 | [symbol] | [symbol] | [symbol] | [symbol] | [symbol] | [symbol] | [symbol] |

Game format GMM1:

The picture matching games generated in game format GMM1 will be called

### Picture Touch Games.

For each Picture Touch Game, the Game Generation Module will generate and display one or more correct pictures and one or more incorrect pictures on the user interface at the same time. Speech or text for a learning item of the selected language will be provided for the player to listen to or read. The player is required to select and touch all the correct picture(s) that match the meaning of the speech or the text provided.

A countdown timer may be added to limit the time of selection such that the player is required to select and touch a picture within a limited period of time,

As the meanings of some learning items (words, phrases or sentences) may not be well depicted by pictures, educational demonstration that displays the translation of a new learning item for a corresponding new picture may be added to the beginning of each game such that the player can fully understand what word, phrase or sentence is depicted by the new picture.

As only one learning item will be provided for picture matching in each Picture Touch Game, the number of Picture Touch Games generated for a game level will be equal to the number of learning items contained in the game level.

For the game format GMM1, the Learning Contents and Progress Management Module contains the mechanism with the table of Booleans below to manage the player's access to different game levels,

Table of Booleans ATDx for game levels LVx
that contain speeches of different languages:

| | L1S | L2S | L3S |
|---|---|---|---|
| ATD1 | Y | Y | Y |
| ATD2 | N | Y | Y |
| ATD3 | N | Y | N |
| ATD4 | N | Y | N |

For LLS=Lq and GTS=S, the values of the column LqS will be applied for ATDx.
The value of ATDx will be applied for game level LVx.

### Therefore,

For LLS L1 and GTS=S, the values of the column L1S will be applied for ATDx.
For LLS=L2 and GTS=S, the values of the column L2S will be applied for ATDx,
For LLS=L3 and GTS=S, the values of the column L3S will be applied for ATDx.
For game level LV1, ATD1 is applied.
For game level LV2, ATD2 is applied.
For game level LV3, ATD3 is applied.
For game level LV4, ATD4 is applied.

Table of Booleans ATDx for game levels LVx
that contain texts of different languages:

| | L1W | L2W | L3W |
|---|---|---|---|
| ATD 1 | Y | Y | Y |
| ATD2 | Y | N | Y |
| ATD3 | N | N | Y |
| ATD4 | N | N | N |

For LLS=Lq and GTS=S, the values of the column LqW will be applied for ATDx.
The value of ATDx will be applied for game level LVx.

### Therefore,

For LLS=L1 and GTS=W, the values of the column L1W will be applied for ATDx.
For LLS=L2 and GTS=W, the values of the column L2W will be applied for ATDx.
For LLS=L3 and GTS=W, the values of the column L3W will be applied for ATDx.
For game level LV1, ATD1 is applied.
For game level LV2, ATD2 is applied.
For game level LV3, ATD3 is applied.
For game level LV4, ATD4 is applied.

For the game format GMM1, the Learning Contents and Progress Management Module also contains the learning item(s) for different game levels.

| Game Level | Learning Items |
|---|---|
| LV1 | T3, T4 |
| LV2 | T1, T2, T5 |
| LV3 | T6, Tr1, Tr2 |
| LV4 | T7, Tr3, Tr4, Tr5 |

where Tr1, Tr2, Tr3, Tr4 and Try are random learning items that re randomly selected from the learning items (non-random) of the previously played game level(s).

In the above table, Tr1 is a random learning item that is randomly selected from any one of the learning items on the previously played game levels LV1 and LV2. The game format GMM1 is designed to select different random learning items on the same game level. For example, if Tr1 is one of the previously learnt learning items, then Tr2 will be one of the other previously learnt learning items on the same game level.

Game format GMM2:

The picture matching games generated in game format GMM2 will be called Picture Movement Games.

For each Picture Movement Game, the Game Generation Module will generate and display a number of correct pictures and a number of incorrect pictures to fill in the blocks of a matrix on the user interface at the same time. The speech or text for a learning item of the selected language will be provided for the player to listen to or see. The player is required to select and move a correct picture that matches the meaning of the provided speech or the provided text in order to get three or more of the same pictures (correct pictures or incorrect pictures) connected together vertically or horizontally.

A countdown timer may be added and displayed on the user interface such that the player is required to complete a Picture Movement Game within a limited period of time.

As the meanings of some learning items (words, phrases or sentences) may not be well depicted by pictures, an educational demonstration that displays the translation of a new learning item for a corresponding new picture may be added to the beginning of each game such that the player can fully understand what word, phrase or sentence is depicted by the new picture.

As all the learning items for a game level will be used for picture matching in each Picture Movement Game, there will be only one Picture Movement Game for each game level.

For the game format GMM2, the Learning Contents and Progress Management Module contains the mechanism with the table of Booleans below to manage the player's access to different game levels.

Table of Booleans ATDx for game levels LVx
that contain speeches of different languages:

| | L1S | L2S | L3S |
|---|---|---|---|
| ATD1 | Y | Y | Y |
| ATD2 | Y | N | Y |
| ATD3 | N | N | Y |
| ATD4 | N | N | N |
| ATD5 | N | N | N |

For LLS=Lq and GTS=S, the values of the column LqS will applied for ATDx.
The value of ATDx will be applied for game level LVx.

### Therefore,

For LLS=L1 and GTS=S, the values of the column L1S will be applied for ATDx.
For LLS=L2 and GTS=S, the values of the column L2S will be applied for ATDx.
For LLS=L3 and GTS=S, the values of the column LqW will be applied for ATDx.
For game level LV1, ATD1 is applied,
For game level LV2, ATD2 is applied.
For game level LV3, ATD3 is applied.
For game level LV4, ATD4 is applied.
For game level LV5, ATD5 is applied.

Table of Booleans ATDx for game levels LVx
that contain texts of different languages:

| | L1S | L2S | L3S |
|---|---|---|---|
| ATD1 | Y | Y | Y |
| ATD2 | Y | Y | Y |
| ATD3 | Y | N | Y |
| ATD4 | N | N | Y |
| ATD5 | N | N | Y |

For LLS=Lq and GTS=S, the values of the column L1W will be applied for ATDx.
The value of ATDx will be applied for game level LVx.

### Therefore,

For LLS=L1 and GTS=W, the values of the column L1W will be applied for ATDx.
For LLS=L2 and GTS=W, the values of the column L2W will be applied for ATDx.
For LLS=L3 and GTS=W, the values of the column L3W will be applied for ATDx.
For game level LV1, ATD1 is applied.
For game level LV2, ATD2 is applied.
For game level LV3, ATD3 is applied.
For game level LV4, ATD4 is applied.
For game level LV5, ATD5 is applied.

For the game format GMM2, the Learning Contents and Progress Management Module also contains the learning item(s) for different game levels.

| Game Level | Learning Items |
|---|---|
| LV1 | T2, T3, T5, T6 |
| LV2 | T1, T4, Tr1, Tr2 |
| LV3 | Tr3, Tr4, Tr5, Tr6 |
| LV4 | Tr7, Tr8, Tr9, Tr10, Tr11 |
| LV5 | Tr12, Tr13, Tr14, Tr15, Tr16, Tr17 |

where Tr1, Tr2, Tr3, . . . , Tr17 are random learning items that are randomly selected from the learning items (non-random) of the previously played game level(s).

In the above table, Tr1 is a random learning item that is randomly selected from the learning items on the previously played game level LV1. The game format GMM2 is designed to select different random learning items on the same game level. For example, if Tr1 is one of the previously learnt learning items, then Tr2 will be one of the other previously learnt learning items on the same game level.

### Picture Touch Games in Game Format GMM1

Examples of picture matching games generated in game format GMM1 from the above example of application of the system are shown below.

Assume that the player has selected the following parameters by going through the Game Format Selector (GMS), the Language Selector (LLS) and the Game Type Selector (GTS) respectively and then enters the Game Level Module.

GMS=GMM1 LLS=L1 GTS=S

As GMS=GMM1, the Game Generation Module will adopt the game format GMM1 to generate the required picture matching games called Pictures Touch Games.

After entering the Game Level Module, the player selects the game level LV1 to play on.

Game Level=LV1

As LLS=L1 and GTS=S, the values of the column L1S (in the Table of Booleans ATDx for game levels LVx that contain speeches of different languages) will be applied for ATDx in the Learning Contents and Progress Management Module. As the corresponding Boolean ATD1=Y (preset by the Learning Contents and Progress Management Module), the player is allowed to play on the game level LV1.

After entering the game level LV1, the Game Generation Module will generate Picture Touch Games required for the game level LV1.

According to the Learning Contents and Progress Management Module, the learning items for game level LV1 are shown below.

Learning Items for LV1: T3, T4

According to the game format of Picture Touch Games, the Learning Contents and Progress Management Module will randomly selects only one of the learning items for the game level LV1 to generate a Picture Touch Game required for the game level LV1.

Assume that the learning item T4 is randomly selected from the learning items to generate the 1st Picture Touch Game for the game level LV1.

Selected Learning Item: T4

As GTS=S and LLS=L1, the Speech Content Converter is applied to convert the selected learning item T4 to speech SL1_T4 and the corresponding sound file with filename: SL1_T4.mp3 is provided to generate the correct speech SL1_T4.

Correct Speech: SL1_T4.mp3

The Picture and Learning Item Linkage is applied to convert the :earning item T4 to the corresponding correct picture P4.png.

Correct Picture: P4.png

Meanwhile the Learning Contents and Progress Management Module also applies the Pictures and Learning Items Linkage to provide other pictures (incorrect pictures).

Incorrect Pictures: P2.png, P3.png, P5.png, P6.png, P7.png

### Game Level LV 1: 1st Picture Touch Game

According to the above parameters, the Game Generation Module will randomly display one or more Correct Picture(s) and one or more Incorrect Pictures on the user interface as the 1st Picture Touch Game for Game Level LV1 shown below.

| | | |
|---|---|---|
| P6.png | P3.png | P5.png |
| P3.png | P4.png | P7.png |
| P2.png | P2.png | P4.png |

The Game Generation Module will play the Correct Speech (SL1_T4.mp3) for the player to listen to.

According to the Learning Contents and Progress Management Module, in the Picture Touch Games, the player is required to touch all the Correct Pictures without touching any one of the Incorrect Pictures in order to complete a Picture Touch Game.

If the player touches any one of the incorrect pictures, the player is required to replay the 1st Picture Touch Game. The Game Generation Module will regenerate the 1st Picture Touch Game that contains the same Correct Speech (SL1_T4.mp3) and other Incorrect Pictures for the player to replay. These processes will be repeated until the player completes the 1st Picture Touch Game successfully. An example of the regenerated game is shown below.

### Game Level LV1: 1st Picture Touch Game (Regenerated)

| | | |
|---|---|---|
| P7.png | P4.png | P2.png |
| P3.png | P5.png | P6.png |
| P4.png | P7.png | P5.png |

After completing the 1st Picture Touch Game on the game level LV1, the Learning Contents and Progress Management Module will select another learning item from the other learning items for the game level LV1 to generate the 2nd Picture Touch Game for the game level LV1. This process will be repeated until all the learning items for the game level LV1 are selected to generate all the required games for the game level LV1.

After selecting the learning item T4 for generating the 1st Picture Touch Game on the game level LV1, there is only one learning item left for selection in the learning items for the game level LV1. Therefore the learning item T3 is selected by the Learning Contents and Progress Management Module to generate the 2nd Picture Touch Game for the game level LV 1.

Selected Learning Item: T3

As GTS=S and LLS=L1, the Speech Content Converter is applied to convert the selected learning item T3 to speech SL1_T3 and the corresponding sound file with filename: SL1_T3.mp3 is provided for generating the correct speech SL1_T3.

Correct Speech: SL1_T3.mp3

The Picture and Learning Item Linkage is applied to convert the learning item T3 to the corresponding correct picture P3.png.

Correct Picture: P3.png

Meanwhile the Picture and Learning Item Linkage is also applied to provide other pictures (incorrect pictures).

Incorrect Pictures: P1.png, P2.png, P4.png, P5.png, P6.png, P7.png

### Game Level LV1: 2nd Picture Touch Game

According to the above parameters, the Game Generation Module will randomly display one or more Correct Picture(s) and one or more Incorrect Picture(s) on the user interface as the 2nd Picture Touch Game for Game Levi LV1 shown below.

| | | |
|---|---|---|
| P3.png | P2.png | P3.png |
| P1.png | P2.png | P6.png |
| P4.png | P3.png | P5.png |

The Game Generation Module will play the Correct Speech (SL1_T3.mp3) for the player to listen to.

According to the Learning Contents and Progress Management Module, in the Picture Touch Games, the player is required to touch all the Correct Pictures without touching any one of the Incorrect Pictures in order to complete a Picture Touch Game. A game level is completed if all the Picture Touch Games on the game level are completed.

After completing the 2nd Picture Touch Game on the game level LV1, the Game Level Module will allow the player to be promoted to play on the next game level LV2.

By repeating the above procedures for game level LV1, the Game Generation Module will use the learning items for the game level LV2 and the Game Format GMM1 to generate the corresponding Picture Touch Games for the game level LV2.

After completing the last Picture Touch Game (3rd Picture Touch Game) on the game level LV2, the game level LV2 is completed and the Game Level Module will allow the player to be promoted to play on the next game level LV3. Besides the Learning Contents and Progress Management Module will set ATD2=Y. As ATD2=Y, the player is allowed to directly play on the previous game level LV2 any time. As the value of ATD1 also equals to Y, the player is allowed to replay the games on the previous game levels (LV1 and LV2) that contain the previous learning items for practicing so as to complete the game levels LV3 or LV4 that contain learning item(s) randomly selected from the previous game levels LV1 and LV2.

By repeating the above procedures, different Picture Touch Games for different game levels can be generated from the learning items for different game levels, After completing a game level, the player is promoted to play on the next game level until all the game levels are completed by the player, During this period, the player is allowed to replay the previously completed game level(s) any time.

After completing all the game levels, ATD1=ATD2=ATD3=ATD4=Y. This means that the player is allowed to directly replay any game level for re-practicing speeches of English (LLS=L1 & GTS=S) generated in the Game Format GMM1 (GMS=GMM1) any time.

A countdown timer may be added to limit the time of selection. Such that the player is required to select and touch a picture within a limited period of time.

As the meanings of some learning items (words, phrases or sentences) may not be well depicted by pictures, an educational demonstration that displays the translation of a new learning item for a corresponding new picture may be added to the beginning of each game such that the player can fully understand what word, phrase or sentence is depicted by the new picture.

After completing each game, the Score Evaluating and Recording Module will evaluate the player's score for each game. In this example, the Score Evaluating and Recording Module will add one point of score for touching one correct picture that matches with the correct speech provided and deduct one point of score for touching one incorrect picture. The player's scores for all the completed games will be summed up to form the player's Accumulated Score.

After completing each game level, the Score Evaluating and Recording Module will evaluate and update the player's Individual Language Level for the selected language and the player's Total Language Level. In this example, the player's Individual Language Level for English will be increased by one for completing each new game level and the player's Total Language Level will be equal to the summation of all the Individual Language Levels of the player.

Picture Movement Games in game format GMM2

Examples of picture matching games generated by GMM2 from the above example of application of the system are shown below.

Assume that the player has selected the following parameters by going through the Game Format Selector (GMS), the Language Selector (LLS) and the Game Type Selector (GTS) respectively and then enter the Game Level Module.

GMS=GMM2 LLS=L2 GTS=W

As GMS=GMM2, the Game Generation Module will adopt the Game Format GMM2 to generate the required picture matching games called Pictures Movement Games.

After entering the Game Level Module, the player selects the game level LV2 to play on.

Game Level=LV2

As LLS=L2 and GTS=W, the values of the column L2W (in the Table of Booleans ATDx for game levels LVx that contain texts of different languages) will be applied for ATDx in the Learning Contents and Progress Management Module. As the corresponding Boolean ATD2=Y, the player is allowed to play on the game level LV2.

After entering the game level LV2, the Game Generation Module will generate Picture Movement Games required for the game level LV2.

According to the Learning Contents and Progress Management Module, the learning items for game level LV2 are shown below.

Learning Items: T1, T4, Tr1, Tr2

As Tr1 and Tr2 represents learning items randomly selected from the learning items of the previously played game level LV1, the Learning Contents and Progress

Management Module randomly selects the learning items T3 and T6 for Tr1 and Tr2 respectively. As Tr1=T3 and Tr2=T6, the updated learning items for game level LV2 are shown below.

Learning Items for LV2: T1, T4, T3, T6

According to the Game Format of Picture Movement Games, the Learning Contents and Progress Management Module will randomly selects only one of the learning items for the game level LV2 in the Learning Content Module LCM2 to generate a Picture Movement Game required for the game level LV2.

Assume that the learning item T6 is randomly selected from the learning items to generate the 1st Picture Movement Game for the game level LV2.

Selected Learning Item: T6

As GTS=W and LLS=L2, the Text Content Converter is applied to convert the selected learning item T6 to text WL2_T6 and the corresponding correct text: [symbol] [symbol] is provided.

Correct Text:

[symbol]

The Pictures and Learning Item Linkage is applied to convert the learning item T6 to the corresponding correct picture P6.png.

Correct Picture: P6.png

According to the Learning Contents and Progress Management Module, the other learning items for the same game level will be converted to incorrect pictures for a Picture Movement Game, In this example, the rest of the learning items are shown below.

The Rest of the Learning Items: T1, T4, T3

Incorrect Pictures: P1.png, P4.png, P3.png

### Game Level LV2: 1st Picture Movement Game

As the meanings of some learning items (words, phrases or sentences) may not be well depicted by pictures, an educational demonstration that displays the translation of a new learning item for a corresponding new picture may be added to the beginning of each game such that the player can fully understand what word, phrase or sentence is depicted by the new picture.

According to the Learning Contents and Progress Management Module, the new learning items for game level LV2 are shown below,

New Learning Items: T1, T4

According to the Learning Contents and Progress Management Module, an educational demonstration that displays the translation (from Chinese to English) of the new learning items for the corresponding new pictures is shown below.

| New Picture | P1.png | P4.png |
|---|---|---|
| Chinese | [symbol] | [symbol] |
| English (Translation) | Apple | Papaya |

According to the Learning Contents and Progress Management Module, the correct picture and the incorrect pictures will be duplicated to generate a matrix of 7 pictures in horizontal direction by 8 pictures in vertical direction. If any three or more of the same pictures on the matrix are found to be connected in w consecutive way vertically or horizontally, all the three or more of the same pictures will be replaced by other different pictures (correct picture(s) or incorrect picture(s)). This replacement process will be repeated until no more three of the same pictures on the matrix connected in a consecutive way vertically or horizontally can be found, After all these replacement processes, the matrix of pictures for the 1st Picture

Movement Game on the game level LV2 will be finalized and displayed on the user interface. Meanwhile the Game Generation Module will display the Correct Text:

WL2_T6 for the player to see as below.
Correct Text:

[symbol]

| | | | | | | |
|---|---|---|---|---|---|---|
| P3.png | P2.png | P5.png | P1.png | P7.png | P5.png | P3.png |
| P1.png | P4.png | P6.png | P7.png | P2.png | P1.png | P6.png |
| P4.png | P3.png | P5.png | P4.png | P3.png | P7.png | P5.png |
| P3.png | P2.png | P3.png | P2.png | P7.png | P4.png | P3.png |
| P7.png | P1.png | P6.png | P5.png | P1.png | P2.png | P4.png |
| P4.png | P3.png | P5.png | P3.png | P4.png | P3.png | P5.png |
| P3.png | P1.png | P4.png | P2.png | P6.png | P2.png | P3.png |
| P3.png | P1.png | P4.png | P2.png | P6.png | P2.png | P3.png |

According to the Learning Contents and Progress Management Module, in Picture Movement Games, the player is required to see the Correct Text and move one of the corresponding Correct Pictures on the matrix by swapping its position with the picture above, below, on the left or on the right.

If the player moves any one of the incorrect pictures, the player is required to replay the Picture Movement Game again.

After each correct move, if any three or more of the same pictures on the matrix are found to be connected in a consecutive way vertically or horizontally, all the three or more of the same pictures will be deleted.

After completing each correct move, the Learning Contents, and Progress Management Module will randomly generate new Correct Text that match any one of the pictures shown on the matrix of pictures. The previous Correct Text will be replaced by the new Correct Text on the user interface.

Repeatedly, the player is required to see the new Correct Text and move one of the corresponding Correct Pictures on the matrix of pictures by swapping its position with the picture above, below, on the left or on the right.

The above procedures will be repeated until no more three of the same pictures can be found on the matrix of pictures, If no more three of the same pictures can be found on the matrix of pictures, the game is completed. As each game level only contains one Picture Movement Game, the game level LV2 will be completed it the 1st Picture Movement Game for game level LV2 is completed.

After completing the game level LV2, the Game Level Module will allow the player to be promoted to play on the next game level LV3. Besides the Learning Contents and Progress Management Module will set ATD2=Y. As ATD2=Y, the player is allowed to directly play on the previous game level LV2 anytime. As the value of ATD1 also equals to Y, the player is allowed to replay the games on the previous game levels (LV 1 and LV2) that contain the previous learning items for practicing so as to complete the game levels LV3 or LV4 that contain learning item(s) randomly selected from the game levels LV1 and LV2.

By repeating the above procedures, different Picture Movement Games for different game levels can be generated from the learning items for different game levels. After completing a game level, the player is promoted to ploy on the next game level until all the game levels are completed by the player. During this period, the player is allowed to replay the previously completed game level(s) any time.

After completing all the game levels, ATD1=ATD2=ATD3=ATD4=Y. This means that the player is allowed to directly replay any game level for re-practicing texts of Chinese (LLS=L2 & GTS=W) generated by the Game Format module GMM2 (GMS=GMM2) any time.

A countdown timer can be added and displayed on the user interface such that the player is required to complete a Picture Movement Game within a limited period of time

After completing each game, the Score Evaluating and Recording Module will evaluate the player's score for each game. In this example, the Score Evaluating and Recording Module will add one point of score for moving one correct picture that matches with the correct speech provided and deduct one point of score for moving one incorrect picture. The player's scores for all the completed games will be summed up to form the player's Accumulated Score.

After completing each game level, the Score Evaluating and Recording Module will evaluate and update the player's Individual Language Level for the selected language and the player's Total Language Level, In this example, the player's Individual Language Level for Chinese will be increased by one for completing each new game level and the player's Total Language Level will be equal to the summation of all the Individual Language Levels of the player.

Thus, the present invention provides methods and systems for the players to learn more than one language through playing the speech or text learning games separately anytime and anywhere in amusing and impressive manner. The players learn the languages by repeatedly playing the games containing the game contents which comprise a part of the same learning items to enhance their memory about the learning items.

Having sufficiently described the nature of the present invention according to some preferred embodiments, the invention, however, should not be limited to the structures and functions of the embodiments and drawings. It is stated that insofar as its basic principle is not altered, changed or modified it may be subjected to variations of detail. Numerous variations and modifications that are easily obtainable by means of the skilled person's common knowledge without departing from the scope of the invention should fall into the scope of this invention.

1. A method of providing picture matching game play to learn at least one language by a player with a personal communication device, comprising the steps of:
(a) the player establishing communication between the personal communication device and a language learning game system capable of generating a type of speech learning game and a type of text learning game in a game format selected from a list of game formats adopted by the language learning game system, said speech learning game containing at least one game content associated with a speech learning item and a speech learning item matching picture, said text learning game containing at least one game content associated with a text learning item and a text learning item matching picture;
(b) the player selecting a target language and the type of learning game of interest; and
(c) the player engaging in the learning game by selecting the picture that is matched to the speech learning item contained in the speech learning game or the picture that is matched to the text learning item contained in the text learning game;
wherein the learning items of same semantic meaning in the speech and text learning games are correlated with the same matching picture.

2. The method according to claim 1, wherein the language learning item comprises vocabulary, phrase and sentence.

3. The method according to claim 1, comprising the step of the player selecting the specific game format for the selected game type to initiate the learning game.

4. The method according to claim 1, comprising the step of electronically introducing one or more additional game formats that are not contained in the language learning game system, so that the speech learning game of the text learning game is generated in the introduced game formats.

5. The method according to claim 4, wherein the one or more additional game formats are introduced into the language learning game system by means of a compact disc, a DVD, a USB memory stick, a SD card, a mobile hard drive, or a wire-based or wireless network.

6. The method according to claim 1, wherein the game format is presented in the form of a picture touch game where the player is required to select and touch the matching picture, or a picture movement game where the player is required to select the matching picture and move it in a right direction.

7. The method according to claim 6, wherein the picture movement game is a picture matrix game where the player is required to move the matching picture for positional swap with an adjacent non-matching picture, such that any three or more of the matching picture or the same non-matching picture connected in vertically or horizontally consecutive way are cleared.

8. The method according to claim 7, wherein the picture matrix game continues with a learning item or the same learning item that is matched to any one of the pictures shown in the matrix after the clearing operation.

9. The method according to claim 1, comprising the step of electronically introducing additional game contents associated with desirable learning items and corresponding matching pictures thereof into the language learning game system, so that the generated speech or text learning game contains the additional game contents.

10. The method according to claim 9, wherein the additional game contents are introduced into the language learning game system by means of a compact disc, a DVD, a USB memory stick, a SD card, a mobile hard drive, or a wire-based or wireless network.

11. The method according to claim 1, wherein the language learning game system generates the speech learning game and the text learning game according to different game levels.

12. The method according to claim 11, wherein the player is allowed for the game play at a next game level only after the learning game at a current game level is completed.

13. The method according to claim 11, wherein the game content of the speech or text learning game at the next game level contains one or more language learning items originated from the previous game level or levels of the learning game.

14. The method according to claim 11, comprising the step of the player playing the completed learning games of different game levels repeatedly to review the language learning items.

15. The method according to claim 1, further comprising the step of displaying a demonstration of a specific correlation of a language learning item with a matching picture thereof before, during and after the game play, thereby the player understands such a specific correlation.

16. The method according to claim 15, wherein the demonstration includes a spoken or written translation of the language learning item into a language known by the player for the matching picture.

17. The method according to claim 1, wherein the player earns a player individual score for completion of each learning game, and the language learning game system accumulates the individual score of the player to form a player accumulated score.

18. The method according to claim 17, further comprising displaying and comparing the player accumulated scores of different players.

19. The method according to claim 1, wherein the language learning game system provides the speech learning game and the text learning game to learn a plurality of languages, wherein the learning items of the plurality of languages, which have the same semantic meaning, are correlated with the same matching picture.

20. The method according to claim 1, wherein the player engages in the learning game by selecting the matching picture within a period of time.

21. A system of providing picture matching game play to learn at least one language by a player with a personal communication device, comprising:
a language learning game system in communication with the personal communication device, comprising:
a database comprising a speech sub-database for storing and updating speech learning items, a text sub-database for storing and updating text learning items, and a picture sub-database for simultaneously providing language learning item matching pictures for the speech learning items and the text learning items, wherein the speech and text learning items of the at least one language, which have the same semantic meaning, are correlated with the same matching picture;
a game generation module for generating a type of speech learning game and a type of text learning game in a game format selected from a list of game formats adopted by the language learning game system, said speech learning game containing at least one game content associated with a speech learning item and a speech learning item matching picture, said text learning game containing at least one game content associated with a text learning item and a text learning item matching picture;
a language selector for permitting to select a target language;
a game type selector for permitting to select the game type for game play; and
a module for permitting the player to engage in the game by selecting the picture that is matched to the speech learning item contained in the speech learning game or the picture that is matched to the text learning item contained in the text learning game.

22. The system according to claim 21, wherein the language learning item comprises vocabulary, phrase and sentence.

23. The system according to claim 21, further comprising a game format selector for permitting to select the specific game format for the selected game type to initiate the learning game.

24. The system according to claim 21, wherein one or more additional game formats that are not contained in the language learning game system are electronically introduced, so that the speech learning game or the text learning game is generated in the introduced game formats.

25. The system according to claim 24, wherein the one or more additional game formats are introduced into the language learning game system by means of a compact disc, a DVD, a USB memory stick, a SD card, a mobile hard drive, or a wire-based or wireless network.

26. The system according to claim 21, wherein the game format is presented in the form of a picture touch game where the player is required to select and touch the matching picture, or a picture movement game where the player is required to select the matching picture and move it in a right direction.

27. The system according to claim 26, wherein the picture movement game is a picture matrix game where the player is required to move the matching picture for positional swap with an adjacent non-matching picture, such that any three or more of the matching picture or the same non-matching picture connected in vertically or horizontally consecutive way are cleared.

28. The system according to claim 27, wherein the picture matrix game continues with a new learning item or the same learning item that is matched to any one of the pictures shown in the matrix after the clearing operation.

29. The system according to claim 21, wherein additional game content associated with desirable learning items and corresponding matching pictures thereof are electronically introduced into the language learning game system, so that the generated speech or text learning game contains the additional game contents.

30. The system according to claim 29, wherein the additional game contents are introduced into the language learning game system by means of a compact disc, a DVD, a USE memory stick, a SD card, a mobile hard drive, or a wire-based or wireless network.

31. The system according to claim 21, wherein the game generation module is configured to generate the speech learning game and the text learning game according to different game levels.

32. The system according to claim 31, further comprising a game level module configured to control the game levels of the game play such that the player is allowed for playing the game at a next game level only after the learning game at a current game level is completed.

33. The system according to claim 31, wherein the game content of the speech or text learning game at the next game level contains one or more language learning items originated from the previous game level or levels of the learning game.

34. The system according to claim 21, further comprising a learning contents and progress management module configured to manage the language learning items contained in the game contents of the speech or text learning games and manage the learning progress of the player.

35. The system according to claim 34, wherein the learning contents and progress management module permits the player to play the completed learning games of different game levels repeatedly.

36. The system according to claim 21, further comprising a game demonstration module for demonstrating a specific correlation of a language learning item with a matching picture thereof before, during and after the game play, thereby the player understands such a specific correlation.

37. The system according to claim 36, wherein the demonstration includes a spoken or written translation of the language learning item into a language known by the player for the matching picture.

38. The system according to claim 21, further comprising a score evaluating and recording module for evaluating and recording a player individual score earned by the player for completion of each learning game and accumulating the individual score of the player to form a player accumulated score.

39. The system according to claim 38, wherein the score evaluating and recording module comprises a comparison module configured to compare and display the player accumulated scores of different players.

40. The system according to claim 21, further comprising a picture and learning item linkage configured to provide the game matching picture for the learning items of same semantic meaning in the speech and text learning games.

41. The system according to claim 40, further comprising a speech content converter configured to convert the speech learning items of same semantic meaning of a plurality of languages into a same speech code and connected to the picture and learning item linkage for correlating the speech learning items with the same matching picture.

42. The system according to claim 40, further comprising a text content converter configured to convert the text learning items of same semantic meaning of a plurality of languages into a same text code and connected to the picture and learning item linkage for correlating the text learning items with the same matching picture.

43. The system according to claim 40, wherein the speech learning items of same semantic meaning of a plurality of languages are assigned with respective identification codes, said identification codes having a same end-bit code which correlates the speech learning items with the same matching picture.

44. The system according to claim 40, wherein the text learning items of same semantic meaning of a plurality of languages are assigned with respective identification codes, said identification codes having a same end-bit code which correlates the text learning items with the same matching picture.

45. The system according to claim 21, further comprising a timer module for providing a time limit for playing the game.

46. The system according to claim 21, further comprising a server which is operative for reactive exchanges with the player.
